(19) United States
(12) Patent Application Publication
(10) Pub. No.: US 2009/0282067 A1
(43) Pub. Date: Nov. 12, 2009

(54) SYSTEM AND METHOD FOR GENERATING CONTROL SYSTEM DATABASE AND GRAPHICS FROM SCHEMA-BASED INTERMEDIATE DESCRIPTIONS

(75) Inventors: Venkatesh Bendigeri, Hyderabad (IN); Sriharsha Vardhan, Hyderabad (IN); Mark Aylward, Brighton (GB); David Edward James, West Sussex (GB); Alexander Park Johnson, Houston, TX (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems, Inc., Foxboro, MA (US)

(21) Appl. No.: 12/393,032

(22) Filed: Feb. 25, 2009

Related U.S. Application Data
(60) Provisional application No. 61/031,327, filed on Feb. 25, 2008.
(60) Provisional application No. 61/031,342, filed on Feb. 25, 2008.

(51) Int. Cl. G06F 17/30; G06F 9/45

(52) U.S. Cl. 707/101; 717/136; 707/E17.044

(57) ABSTRACT

A method and system for automatically generating process control databases and process graphics for a distributed control system is disclosed herein. Programmed process control database and process graphics generators automatically render output in a target process control system environment (e.g., InFusion Engineering Environment—or IEE) from an intermediate (e.g., XML) representation of process control and process graphics definitions.

### CROSS-REFERENCE TO RELATED APPLICATIONS

This application claims the priority benefit of Bendigeri et al., U.S. Provisional Patent Application Ser. No. 61/031,327, filed on Feb. 25, 2008, and Bendigeri, U.S. Provisional Patent Application Ser. No. 61/031,342, filed on Feb. 25, 2008, the contents of which are incorporated herein by reference in their entirety, including the contents of any references contained therein.

### TECHNICAL FIELD

The present invention generally relates to the field of programmable/configurable computerized distributed control systems. The invention relates to the maintenance, development and deployment of distributed control systems and associated graphical views for such systems. More particularly, the invention relates to tools/utilities that are used to generate a configuration of a distributed control system for a particular type of process control system/protocol (e.g., Foxboro I/A) from higher level generic definitions of such control programs.

### BACKGROUND

The design and construction of a new or retrofit process (power, chemical, refinery or other) plant is incredibly complex and expensive, involving designers, engineers, and construction teams from many different companies and disciplines, all attempting to perform their work in parallel to get the plant built and up-and-running in the shortest time possible. Typically there is one entity responsible for the design, construction, and turnkey delivery of the plant to the end client: the Engineering Procurement Construction Contractor (EPC). The EPC subcontracts and manages individual suppliers, which includes the control system and operator training simulator providers.

The sooner the plant is up-and-running, the sooner the end client starts earning revenue on their production, sometimes easily totaling millions of dollars per day for a large plant. Thus, project incentives and penalties are used to motivate suppliers to accelerate schedule. For control system (and other) providers, the negative side of this is that the plant design can be iterative” as multiple teams scramble to finish their work, leading to major system design revisions that potentially force rework. Depending on the contract structure, these rework costs are not always recoverable.

FIG. 1 shows a typical hardware layout for a plant control system. For the purposes of the description of the illustrative embodiments, a control system potentially includes, in addition to a distributed control system, a safety instrumentation system, emergency shutdown system, fire and gas system, or any combination thereof. The control system uses control blocks to execute logical and mathematical functions to control the physical processes in the plant. These are configurable software blocks which are processed by the system's control processors (see, FIG. 1, control processors 100). The communication to/from plant instrumentation and actuators 101 are via Input/Output modules (I/O modules) 102 connected to the plant instrumentation and actuators 101 via an I/O marshalling rack 103. The exemplary process control system also includes an operator environment 104 comprising a suite of plant control system and process visualization applications/user interfaces. An example of a plant process visualization application is INVENSYS SYSTEMS, INC's. FOXVIEW human machine interface application.

### SUMMARY OF THE INVENTION

A system and method are described herein for automatically generating a distributed control system database from an intermediate representation. The system comprises one or more programmed computers that are configured to provide a control system configuration definition in an intermediate schema-based description language. The computer system also provides a rules database defining a set of rules for transforming from the intermediate schema-based language to a target control database format. Furthermore the system is programmed to apply the set of rules to the control system configuration definition to render a distributed control system database.

A system and method are also described herein for automatically generating distributed control system graphics from an intermediate representation. The system comprises one or more programmed computers that are configured to provide a control system graphics definition in an intermediate schema-based description language. The computer system also provides a rules database defining a set of transformations from the intermediate schema-based language to a target graphics format. The system is furthermore programmed to apply transformation rules from the rules database to the control system graphics definition to render distributed control system graphical views including resolved aliases.

### BRIEF DESCRIPTION OF THE DRAWINGS

While the claims set forth the features of the present invention with particularity, the invention, together with its objects and advantages, may be best understood from the following detailed description taken in conjunction with the accompanying drawing of which:

FIG. 1 is an exemplary network drawing depicting a typical hardware layout for a plant control system;

FIG. 2 is a schematic drawing showing and exemplary arrangement of software components in a system incorporating an auto generation architecture;

FIG. 3 is a block diagram depicting exemplary protocol adaptor arrangement;

FIG. 4 is a flowchart summarizing steps for an exemplary auto generation workflow;

FIG. 5 is block diagram showing an exemplary auto generation system arrangement;

FIG. 6 is an exemplary a macro template profile and user attributes;

FIG. 7 is a flowchart summarizing an exemplary set of steps for auto generation of a process control database in a target (e.g., IEE) process control system environment;

FIGS. 8-14 illustratively depict a variety rules used by the auto generation module to render a process control database in a target process control environment;

FIG. 15 is a block diagram showing an exemplary auto graphics generation arrangement; and

FIG. 16 is a flowchart summarizing the operation of a auto graphics generator module for rendering FoxView process graphics from SP P&ID objects.

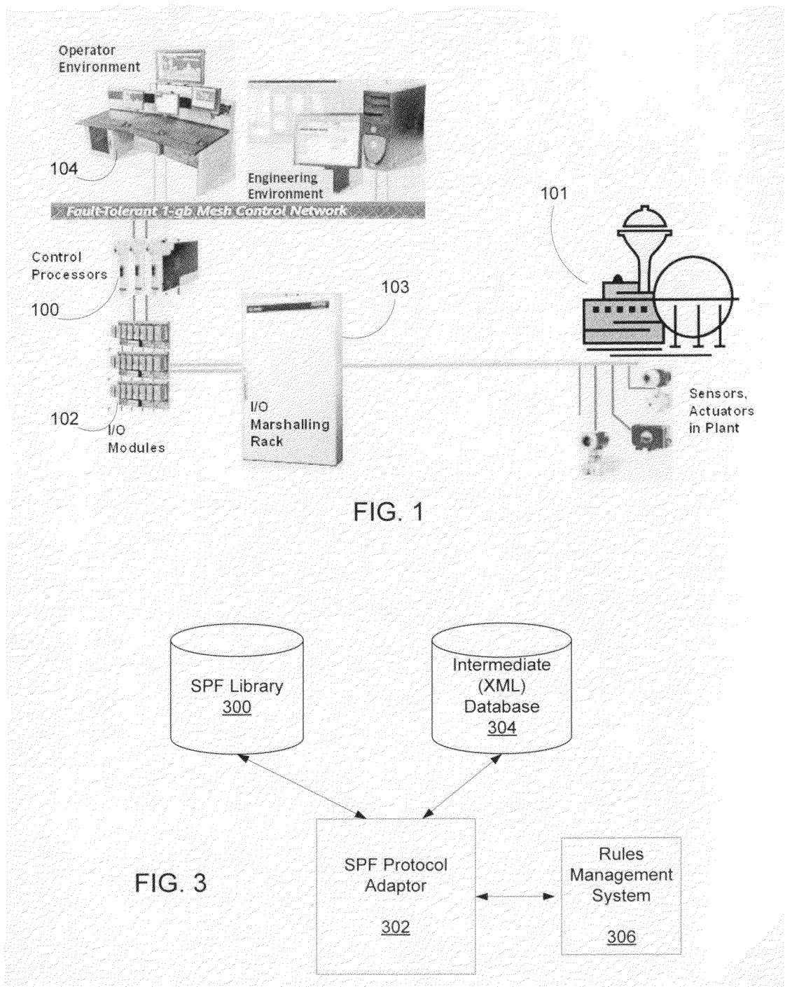

### DETAILED DESCRIPTION OF THE DRAWINGS

The following description is based on illustrative embodiments of the invention and should not be taken as limiting the invention with regard to alternative embodiments that are not explicitly described herein.

The distributed process control system control database and graphics generators described herein are described with reference to illustrative source, intermediate and target languages/applications. A first feature described herein relates to generating a distributed process control system database, comprising inter-connected function blocks, from an intermediate XML schema-based description of the distributed process control system. The XML schema-based description itself is rendered from a source control system description (INTERGRAPH SMART PLANT INSTRUMENTATION), provided in the form of templates, using known conversion tools. The conversions from source to target representations of a distributed control system are driven by sets of rules applied by the generator to render a description in either the intermediate (XML) or target (INVENSYS SYSTEMS, INC. InFusion Engineering Environment —“IEE”) form.

A second feature described herein relates to generating process visualization (human-machine interface) displays in a destination application format (e.g., INVENSYS SYSTEMS, INC. FOXVIEW) from an intermediate descriptive (e.g., XML) format. The intermediate version is, in turn, derived from, for example, generic process graphics objects (e.g., SMART PLANT Piping and Instrumentation Diagram drawings—SP P&ID drawings). The conversions from source to target representations of control system graphics are driven by sets of rules applied by a graphics generator to render a description in either the intermediate (XML) or target (FOXVIEW) form.

The aforementioned first and second features enable automatic building of a process control system database and graphical displays, and this functionality is facilitated by incorporating a user-defined rulebook that uses control block naming conventions, combined with use of a user community defined template library.

The auto-generation architecture described herein addresses a general need to reduce the time and engineering effort and delivery schedule for large applied systems. In particular, the present invention addresses the need to eliminate delays in rendering a distributed control system control program database from a generic (XML-based) definition of the control program. In particular, the claimed invention addresses a need to render a control database from an XML control definition.

The disclosed auto-generation architecture addresses the task of process control system program development, and is focused on automation of engineering and processes required to deliver fully engineered and configured process control systems that are used to control a variety of industrial/manufacturing systems.

The disclosed system and method for automatic generation of a process control database (from an intermediate XML-based) definition of the control system potentially: significantly reduces the man-hours required to configure and stage hardware and standard software and to configure and test applications; significantly reduces the project schedule from receipt of order to plant production and encompasses projects for new process plant, expansion of existing plant and migration of legacy automation systems. These objectives are achieved by: translating plant design data, as captured electronically in, for example, Intergraph's SmartPlant in XML format, into hardware, software and application configurations for deployment to target equipment; and providing tools for translating or mapping plant design data into IPS product configuration data.

The auto-generation systems and methods described herein facilitates: use of a single source of data for all process control configuration tools, automating the transfer of data from plant design applications to configuration applications, leveraging Intergraph's SmartPlant offering to capture clients' design requirements, and leveraging Intergraph's SmartPlant Foundation (SPF) to automate engineering and configuring processes required to deliver process control systems.

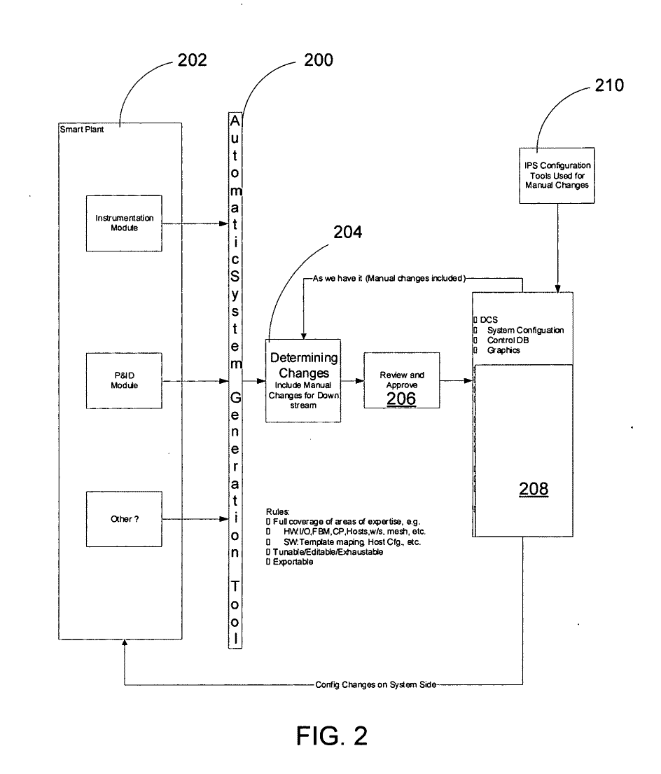

FIG. 2 illustrates a generalized/summary view of the auto-generation architecture implemented on a computer system in the form of program code stored on a computer-readable medium. In addition to auto-generation of control databases and graphics, the illustrative computer-system supports instruction and retention of manually entered changes to the control database and graphics descriptions. An auto-generation tool 200 extracts source control and/or graphics object data from a SmartPlant template library 202 and transforms the control/graphics data, a change management tool 204 compares the transformed data to current system databases, a configuration tool 206 enables review and approval of any changes. The updates are then stored in the system database 208. The configuration tool 206 is intended to supplement already existing control database configuration tools 210. Furthermore, the auto-generation architecture supports moving selected data back into the SmartPlant template library 202 (e.g., corrections to bad data from the SmartPlant library 202), and it must support the preservation of manually entered changes using the normal system configuration tools.

### I. The Auto-Generation Architecture (Generally)

The auto-generation system described herein includes a first feature directed to auto-generating distributed control system databases and process control graphics from intermediate (XML) descriptions. The auto-generation of distributed control systems and associated graphics incorporates the following features:
a) Mapping INTERGRAPH SmartPlant objects to I/A Series objects and forming associations that guide the creation of control structures, displays, and system definitions;
b) Supporting automatic system configuration and testing
   i) Applying rules to a customer's plant model database to generate system configuration, I/O loading, cabinet configuration and documentation drawings
   ii) Applying rules to a customer's plant model database to generate generic controller configurations based on I/O modules, group displays and historian for hardware checkout
c) Supporting automatic control and gateway configuration and testing
   i) Applying user defined data conversions to the customer's plant model database to create an input useable by the INVENSYS SYSTEMS, INC. InFusion Engineering Environment (IEE)
   ii) Bulk generating control & I/O function blocks from a plant model database
   iii) Creating a tool to support automated integrity checks between I/A Series and plant model databases
d) Supporting automatic HMI (FoxView) Configuration
   i) Generating FoxView process displays from generic descriptive formats contained in plant model database
   ii) Generating InFusion view process displays from plant model database
   iii) Generating FoxView menu structure from the plant model database's plant breakdown structure
   iv) Generating an InFusion view menu structure from the plant model database's plant breakdown structure

The rules-driven auto-generation systems and methods described herein provide a variety of functions including the following described herein below. Regarding the auto-generation of process control configurations, the auto-generation system supports exporting a control configuration from a SmartPlant Instrumentation (SPI) format to a target IEE format. In particular, the auto-generation architecture includes a rules-driven integration tool that bulk exports representations of control loops, configured/defined in SPI format to create a deployable I/A Series control configuration for use in IEE. Furthermore, the rules-driven integration tool selectively exports updated (add, delete, modify parameters/attributes, reassign objects) representations of a previously generated/created I/A Series control strategy, originally configured in SPI format, to modify the deployable IEE control configuration.

Conversely, the rules-driven integration tool supports importing process control configuration from the IEE process control database to an SPI project database. In particular, the integration tool imports a representation of an I/A control strategy template (from IEE) with its associated rules as an instrument panel type in the SPI project database. The integration tool also supports selectively importing updated (add, delete, modify parameters/attributes, reassign objects) representations of I/A Series control strategy templates, configured in IEE, to modify corresponding SPI representations in the SmartPlant database.

Regarding the auto-generation of process control graphics, the auto-generation system supports exporting display configuration information from SmartPlant piping and instrumentation diagrams (SP P&ID) to INVENSYS SYSTEMS, INC. FOXVIEW display definitions. In particular the integration tool automatically creates process operator displays provided, for example, on the operator environment 104, for selected portions of SP P&ID drawings maintained in SP P&ID form in a SmartPlant project database. The integration tool automatically creates both static and updated process graphic elements that represent selected items on an SP P&ID drawing placing it in the same relative position on the graphic as it appears on the original SP P&ID drawing. Furthermore, the integration tool automatically generates names for automatically generated FoxView graphic displays and objects based upon user defined rules and the SP P&ID project database names for a Plant, Area, Unit, P&ID drawing and instrument tag name.

In the section of the detailed description that follows, an exemplary high level auto-generation architecture for rules-driven generation (and synchronization) of a process control database and process control graphics from generic (e.g., XML) descriptions is described. By way of example, plant design process control and graphics data are stored, for auto-generation, as XML representations of template and plant design data in an IPS defined database on a SQL server. The SQL server stores the plant design process control and graphics data in its intermediate (e.g., XML) form according to a standard schema that enables the aforementioned integration tool to automatically render corresponding process control database and graphics views according to a set of pre-defined rules.

This section describes a general approach to auto-generation of process control database and graphics views.

Pre-Requisite

In accordance with an exemplary embodiment, it is considered a pre-requisite for such auto-generation that each I/O point is assigned to exactly one loop though it may be referenced in non-owning loops. This requirement allows the integration tool to determine which template matches a given loop.

Process Control Database Generation

The basic concepts in generating process control databases in IEE from templates (e.g., SPI templates) and I/O lists, in an exemplary embodiment, are:

1) I/O points are assigned to process control loops before control scheme generation is attempted.

2) Templates have characteristics that must be matched by a candidate loop for a template assignment to be certain.

3) Matched characteristics of a template, for example, include:
a. number of inputs and outputs
b. type of inputs and outputs, (e.g., analog and discrete)
c. engineering units on inputs and outputs

4) Loops must have the same set of characteristics.

5) It must be possible for each loop characteristic to be determined from information in the SmartPlant database (e.g., SPI and SP P&ID).

6) The template characteristics are either calculated when a template is read or are entered as part of template creation.

With the above-described arrangement, it is possible to create a loop object, generate its characteristics, and assign it to a process control template for which it has the greatest similarity, i.e., the highest scoring match.

Once all loops are assigned to a process control template, the integration tool creates either: all of the records required for the required blocks for use by the IEE's bulk object editor, or a script for use with an IEE configuration/editor tool.

Process Graphics Generation

Automatic generation of process graphics, by way of example, relies on the following pre-requisites: the SP P&IDs are assigned to plant areas in a plant breakdown structure, the SP P&IDs are converted to XML format using a particular protocol/schema (e.g., Noumenon's XMpLant), the P&IDs are filtered to remove irrelevant objects, the control loop template assignments for each loop has been completed, and there is a exactly one graphic templates for each control strategy template. When the pre-requisites are met, the integration tool creates a FoxView process graphic for each SP P&ID and replaces the SP P&IDs default symbols with FoxView templates. In an exemplary embodiment other transformations, e.g., color assignment based on material type, are also made.

Turning to FIG. 3 the data flow is illustratively depicted with reference to programmed computer-implemented components of an exemplary auto-generation architecture. The exemplary system includes an SPF library 300 containing: process control templates and P&IDs defined according to a set of SmartPlant Foundation (SPF) process control element definition rules.

In the illustrative example, a first protocol adaptor 302 converts object templates for both process control and graphics into an intermediate (XML) form. The XML definitions of the object templates are stored in an intermediate database 304 (e.g, an SQL database). The first protocol adaptor 302, by way of example, retrieves or publishes the data from the SPF library 300 (e.g., SPF database) and publishes or retrieves data to the intermediate database 304. The adaptor 302, by way of example, uses an SPF schema to retrieve and publish data to the library 300 and uses a second schema to retrieve and publish data to the intermediate (XML) database 304. The second schema is utilized by a variety of clients (including the integration tool) of the intermediate database 304 to access the contents of its tables.

The first protocol adaptor 302 supports publishing and retrieving process control and P&ID data from the SPF library 300 and the intermediate database 304. The first protocol adaptor 302 accesses various files such as a tool map schema file, a component schema file and data files during retrieve/publish from/to SPF and IPS databases. The tool map schema file is, for example, created as an equivalent to an Invensys Process Systems (IPS) schema. Each project potentially includes its own tool mapping schema file. In an exemplary embodiment, a SmartPlant schema editor facilitates creating/revising tool map schemas. The tool map schema file, component schema file and data files are all stored, for example, in XML format.

In the exemplary embodiment, the first protocol adaptor 302 retrieves data from a data file in the SPF library 300 (e.g., SPI and SP P&ID files) by traversing through Tool Map Schema and Component Schema and stores in the IPS database as specified by the IPS Schema. It also publishes data to SPF using the same tool map schema and component schema files. During conversion from SPF library 300 format to intermediate database 304 format, the first protocol adaptor 302 writes the SPF library file data into an IOTaglist table of the intermediate database 304. The adaptor 302 generates a unique ID for each tag entered into the intermediate database 304. The new incoming data read from the data file in the library 300 is appended to the IOTaglist table and the existing data is updated in the intermediate database 304.

With continued reference to FIG. 3, the aforementioned integration tool comprises distinct modules for converting process control database and process graphics from an intermediate (XML) format to a format suitable for a particular process control system environment (e.g., IEE).

The operation of the conversion to the intermediate (XML) database 304 format is guided by automated conversion rules maintained in the rules management system 306. In an exemplary embodiment, the rules management system comprises a set of functional components for defining the rules used by the auto generation system (both control database and graphics). The rules management system 306 includes a user interface (PWFV) enables an end user to interface the auto generation functionality described herein. The user interface to a project work flow editor. The user starts or stops a process flow from the user interface.

A work flow & rule editor of the rules management system 306: This module facilitates defining the work flow for a project. ReThink will be used as the graphical design environment for animation, analysis and work flow automation tool. This tool is used by analysts to design work flows for a project. The work flow and rule editor tool is used by analysts and developers to define the rules, methods and procedures using a structured language.

A rules repository component of the rules management system contains all the relevant rules for carrying out the auto generation functionality described herein. This is a centralized location where all rules are stored, creating a platform for easy migration and transfer during the various phases of project development. The rules repository creates the possibility of storing different versions of a rule definition and recording the history of changes and supports the versioning of rules.

A configuration component of the rules management system is used to generate a configuration file for each project. The class administrator uses this application to configure the project. The configuration file contains intermediate database server details and information required by external applications.

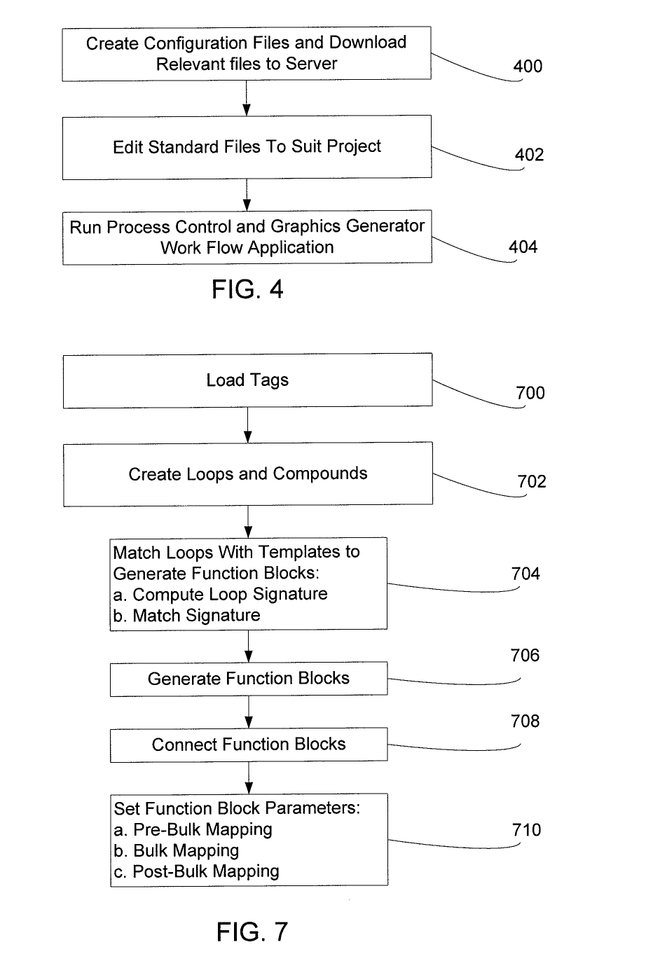

FIG. 4 summarizes a set of stages associated with an operating environment including the exemplary process control database and process graphics auto-generation system. During stage 400 an administrator creates configuration files (e.g., rules) and setup required for a plant configuration project to run. The administrator also downloads any relevant standard files and project-specific files into a project-specific directory in a server. Thereafter, during stage 402 a user modifies the previously loaded standard templates to suit the needs of a particular process control system design project. Thereafter, during stage 404 a user invokes a process work flow application that guides a user through a list of sub-steps for rendering a process control database and process graphics in the IEE. Upon completion of the stage 404 the project is configured and ready for deployment to process control system hardware (e.g., download configured process control blocks to control processors). These steps are described herein below.

During step 400, an administrator performs the following exemplary actions. The administrator initially creates a project directory structure and database (in database 304). By way of example, the administrator also runs a create-configuration application to create a class config.txt file with the following information: server location, name of the project, project folder path, intermediate database location for the project, SP database location for the project, SP-P&ID graphics location for the project, location of the standard files, standard template location, location of the output files (Documents, files etc generated from applications) to be stored, name of the user personal computer (the one used by the project engineers).

During step 402 the engineer modifies any standard files to meet particular project needs.

During step 404, in an exemplary embodiment a user initiates a process control database and process graphics generation workflow for a project by selecting an option from user interface of a workflow application. The user can choose one of the following options.

1. Get data from adapter

2. Generate control database

3. Generate graphic database

The end user can initiate an action to get data from the Smart Plant 300 and store it in the intermediate database 304 from the workflow application. To generate a control database, the work flow that is defined for this process (in kb modules) is activated along with rules that are applicable to generate the control database.

The following process is used to generate the control database.

1. Strategy templates are loaded into the intermediate database 304 using a configurator.

2. Input data is validated.

3. Generate Loop which includes the block parameters, intermediate blocks block to connections, block naming, loop naming etc.

4. Generate compound names.

5. Allocate the Hardware for the loops—CP is allocate, FBM naming, FBM type, ECB allocation, point numbers etc.

The above five steps are automatically performed when the user invokes the integrator tool on an identified project (or portion thereof) to render a process control database in the IEE.

Similarly, when a user invokes the integrator tool on an identified project to generate process graphics, the integrator tool retrieves the appropriate graphics files from the intermediate database 304 (corresponding to SP P&ID drawings from the SPF library 300) and renders FoxView (.fdf) files using the XMpLant application. Static displays are initially generated from the SP P&ID drawings and thereafter aliases are resolved to generate dynamic symbols tied to the process variable tags of the process control system.

### II. Auto-Generation of Process Control Database

Having generally described the auto-generation architecture, attention is directed to a more detailed description of the generation of a process control database, by a direct access (DA) module of the integrator tool according to a set of rules and an intermediate (XML) definition of process control templates. The DA component is launched from the workflow application during step 404. The functional specification of the DA module is as follows:
1. The DA module takes the input from the intermediate database 304 and generates the control database (for the IEE) using data taken from the sources given below.
   a. Intermediate database 304 schema for table lookup.
   b. Data from the intermediate database 304
   c. Data from a template dictionary
2. A command line interface is supported.
3. Data is retrieved from the intermediate database 304 according to the intermediate database 304 schema.
4. The DA module supports generation of a portion of a process control database to facilitate deploying a process control database in phases (by plant, area, unit and loop designation).
5. The DA module supports taking changes to the intermediate database 304 and updating an existing database in the IEE.
6. The DA module supports the following flags in the intermediate database 304 against each block.
   a. Created—This flag indicates that the block was created successfully in the database.
   b. Generated—This flag indicates that XML file has been generated.
   c. Downloaded—This flag indicates that loop is downloaded in IEE successfully.
   d. Failed—This flag indicates that loop is failed.
      i. Create Failed—Failed during creation
      ii. Generate Failed—Failed during Generation
      iii. Download Failed—Failed during Download
   e. Modified—This flag indicates that loop is modified
   f. Added—This flag indicates that new block was added in IEE manually.
   g. Deleted—This flag indicates that this block has been deleted.
7. If the Galaxy server is not connected then only the Generate flag will be displayed. User to reconcile manually to the download state.

Having described the operation of the DA module, it is noted that in an exemplary embodiment, the source data for the DA module (batch files containing XML data) is initially rendered by a Control Adaptor (CA) module. Therefore, when the control database generation process (described in detail herein below) is invoked, the CA module takes the previously imported (from SPF library 300) input data from the intermediate database 304, converts the data into XML Batch File that conforms to a predefined schema. The CA module then invokes DA module to export the XML configuration into IEE. The DA module takes the XML batch file as input and generates the process control database configuration output in IEE in deployable format.

In an exemplary software deployment environment, the CA module runs on a server machine and creates the XML batch file on the server. Upon creation of the XML batch file, the CA module transfers the batch file to a client machine running the DA module and sends a trigger command to start execution of the DA module. Thereafter, the CA module periodically polls for the status of the triggered DA module and updates the same status to a workflow manager. On successful completion by the DA module of bulk generation of a control database in IEE, the DA module sends a “done” status message to the CA module and waits for a terminate signal from the CA module. When CA module receives the “done” signal, it sends a “terminate” command to the DA module to end the DA modules execution on the client.

This portion of the disclosure provides a detailed functional description of the portion of the disclosed system that carries out generating a process control database from an intermediate (XML) definition stored in the intermediate database 304. This section provides descriptions of the software stored on a computer-readable medium of a computer system to carry out the process control database generation functionality described herein. In an exemplary embodiment, the generation of a process control database involves the following: control database generation workflow, intermediate database 304, I/O tag validation workflow, rules repository, SmartPlant data reader application, and the IEE control data converter application. These elements of process control database generation are described further herein below.

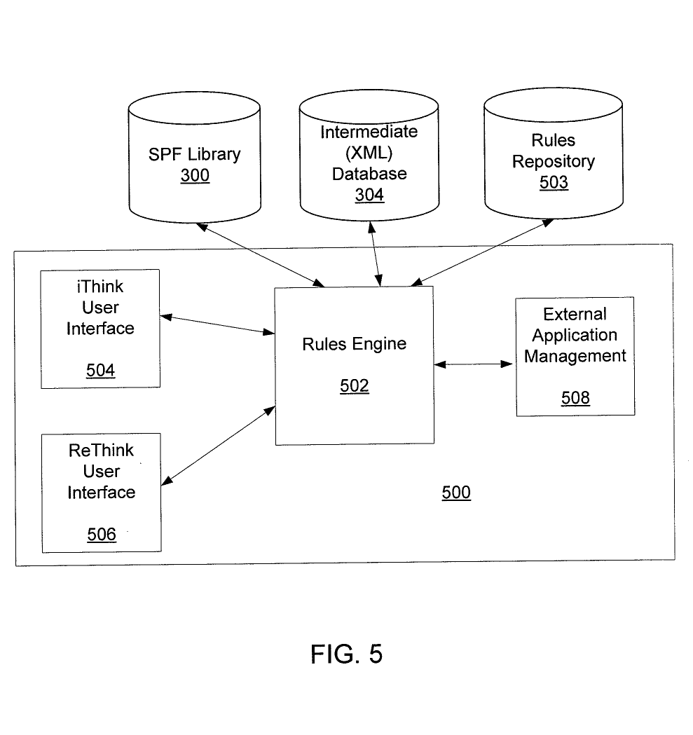

An overview of the software architecture is provided followed by descriptions of each of the six components. An exemplary software architecture for a control database generation (CDbG) application 500 is shown in FIG. 5. The CDbG application 500 automates generating control systems and provides functions for easy management of knowledge, or rules, applied by the application 500. Default values enable rapid configuration and speed to results. Knowledge contained in structured dialogs, natural language if-then rules and process work flows enable process engineers and experienced analysts to modify the logic in the CDbG application 500 without programming. All rules are classified as either managed rules or non-managed rules. Managed rules are designed to be flexible and are generally changed frequently by process engineers or analysts. Non-managed rules may be changed, but are highly stable and do not require frequent change. All other program logic of the CDbG application 500 is embedded in computer code.

Rules within the context of a process work flow in the CDbG application 500 are executed in a rules and workflow engine 502. Rules are maintained within the application 500 as well as externally in a rules repository 503.

The rules engine 502 mediates user interactions through a graphical user interface (UI). In the exemplary embodiment, the application 500 includes two such UI's. An iThink UI 504 (the Process Engineer UI) provides a minimal set of buttons, drop-downs, structured dialogs and output reports to enable control database generation and some rules modification capabilities. A ReThink UI 506 (the Analyst UI) provides a fully-featured user interface that enables experienced application users and control system specialists to modify most of the rules governing control database generation. Analysts are able to adjust all managed rules, and non-managed rules and workflow via the ReThink UI 506. Both the iThink UI 504 and the ReThink UI 506 manage interactions with databases including input of data that come from the SPF library 300, and output of data to the IEE.

Input data is imported and output data is exported by an external application management (EAM) software module 508. The EAM module 508 applications program interface (API) provides general mechanisms for controlling applications external to the rules engine.

The intermediate database 304 is the primary database containing input and output data from the CDbG application. The IPS database contains template data, data input from SmartPlant, application defaults, output data, configuration data and rules parameter data.

The following describes components of the CDbG application 500 that facilitate generating a process control database from an intermediate (XML) definition and a set of rules. Control database generation is initiated by a request. In response, the CDbG application performs the following steps:

1. Load tags from intermediate database 304

2. Create loops and compounds

3. Match created loops with templates and generate function blocks

4. Set block parameters

5. Output object model data, and

6. Insert objects to pools.

These steps are described in detail herein below.

In an exemplary embodiment the rules repository 503 maintains multiple instances/versions of if-then rules and workflows to simplify sharing and maintenance of the knowledge. In the context of this particular example, the term “rules” is used to describe both if-then natural language rules and the workflows into which these rules are embedded. An example of such a rule is the following:

for any ica-fb-cin CIN
if the invalm of CIN=1 then
conclude that the sctxt1 of CIN=the nm0 of CIN
   In this rule an attribute (invalm) of an ica-fb-cin object is checked and if the value of this attribute is 1, a second attribute (sctxt1) of that same object is set equal to the value of another attribute (nm0) of that object. Many rules like this are defined in the CDbG application 500. Terms in the rules are selected to be understood by the person or group that is responsible for managing the rule.

The SmartPlant data reader application reads data from the SPF library 300 into an Iotaglist_SPF table of the intermediate database 304. The input to this application is a comma separated value (csv) file that contains loop information derived from SmartPlant objects. The data columns contained in this file are shown in Table 1.

TABLE 1
Data contained in the CDbG input (comma separated values) file.

| | |
|---|---|
| Internal_Loop_Order | |
| | Min_Inst_Range |
| | Max_Inst_Range |
| Tag_Number | |
| Instrument_Type | Min_Inst_Range_Unit |
| | Max_Inst_Range_Unit |
| Number | |
| | Min_Calib_Range |
| Prefix | |
| | Max_Calib_Range |
| IO_Type_Name | |
| | Min_Calib_Range_Unit |
| Status | |
| | Max_Calib_Range_Unit |
| Service | |
| | Minimum_DCS_Range |
| Suffix | |
| Manufacturer_Name | Maximum_DCS_Range |
| Model_Name | DCS_Range_Unit |
| Old_Tag_Number | |
| | Loop_Number |
| | Generation_method |
| Location | |
| Equipment_Name | |
| | Instrument_Price |
| Drawing_Sequence | |
| | Remark1 |
| Process_Function_Type | Requires_Power_Supply |
| P_ID | Frequency |
| | Instrument_Type_Desc |
| Power_Supply | |
| Tag_Class | Signal_Type |
| Unit_Name | Linear_Type |
| Area_Name | cf_page1 |
| Plant_Name | cf_sub_page |
| Loop_Name | cf_day |
| Loop_Service | Logo |
| Price | Loop |

The IEE control data conversion application converts the results of control database generation into a format that can be read by IEE for completing control system design.

In an exemplary embodiment the CDbG application 500 is built upon an object model that represents data/object concepts managed in a control database generation task. The CDbG object model contains at its highest-level an ICA-OBJECT object class. All application-specific objects used within the CDbG application are subclasses of the ICA-OBJECT class.

Workflow objects are subclasses of the ICA-SCOPE class, which multiply inherits from ICA-OBJECT and a standard work-object BPR-OBJECT.

Macro Templates, or Macro Device Templates, are a set of predefined device templates that possess a unique profile used to match the loop signature to the device. A macro template can comprise multiple embedded sub-templates. Each sub-template contains one or more function blocks. In an exemplary embodiment, during the auto-generation of a process control database, the CDbG workflow matches a loop signature to a signature of a macro template and function blocks contained in the matched macro template are created to generate the functions blocks for the loop. The function blocks are stored to a database after invoking appropriate rules to name the blocks and set certain parameters. Rules also associate appropriate tags with I/O function blocks of the loop.

By way of example, macro templates contain the following information:

The macro template name (e.g. $VLV_{—}02)

The template profile data for loops, which contains the loop signature profile

The subtemplates that contain the function blocks

The template function blocks containing default values for block parameters

Connection specifications between function blocks

User attributes for each template function block including:
Rules for block naming, name validation, name formatting and tag association
Additional data to be used by rules (e.g. regular expression for tag association rule)

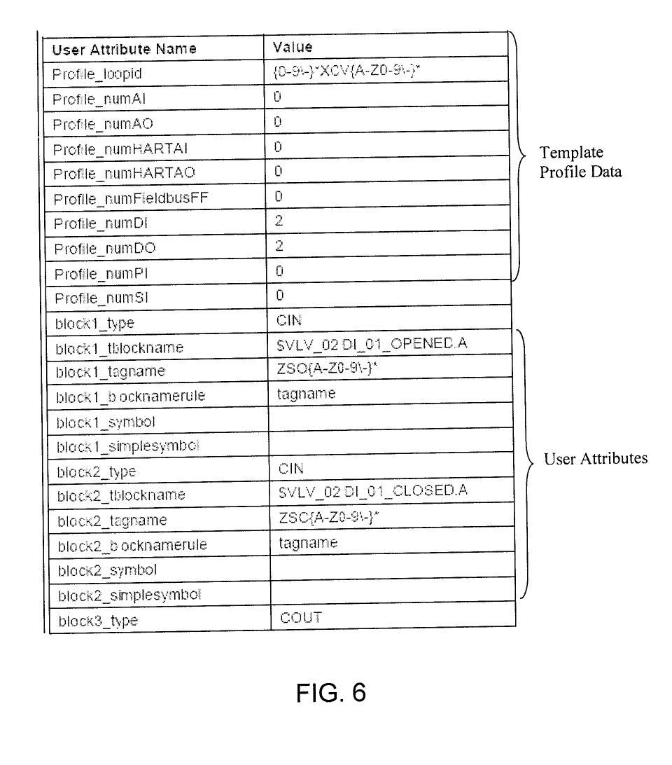

An example of a macro template profile and user attributes is shown in FIG. 6. The macro template profile data is stored in the macro template object whereas the user attribute data is stored in each template function block.

In the exemplary embodiment, three classes of objects make up a macro template in the CDbG application 500:
ica-macro-template: a container object for the subtemplates and contains the macro template profile,
Ica-sub-template: container for the template function blocks,
Ica-function-block: base class for the function blocks of the macro template,

The objects that make up each macro template are organized into a containment hierarchy.

Macro templates are loaded from the intermediate database 304 into the CDbG application 500 at startup and the application 500 automatically creates an object structure for each macro template and contained sub-templates.

Macro templates are loaded using the following database tables:
SStrategy: Used to create the macro template objects and subtemplate objects
SBlockReference: Used to create the template function blocks
SParameterReference: Used to set the default function block parameters in the templates and the connection specifications between connected blocks of a template
SUserAttributes: Used to set the template profile and user attribute data in the template and function blocks.

The sequence of operations for loading and creating macro templates is as follows:
1. Read SStrategy table and create macro template objects. The macro templates are stored in a template pool located in a control generation workspace.
2. Read SBlockReference table and create appropriate sub-template objects under each macro template.
3. Read SParameterReference table and create each template function block under each sub-template object.
4. Read SParameterReference table and populate the template function block parameters with the default values.
5. Read SUserAttributes Set the template profile data in the macro template object. Create and populate template rule data objects with user attribute data.
6. Transfer User Attribute data from rule data objects to template function block attributes.
   User attribute data is stored in rule data objects before being copied to function block attributes. There is normally one rule data object for each template function block. The rule data objects are stored in a template rule data pool on the CDbG workflow top level workspace.

Turning to FIG. 7, the CDbG workflow component of the CDbG application 500 comprises a set of tasks that are executed in series.

(1) Tag Loading (Step 700)

The tag loading task includes a State Info operation used to relay progress information to the user interface. A Get Tags from DB operation executes a SQL query that extracts I/O tags from the intermediate database 304. The query selects only those tags that have a valid macro loop template name. This operation creates ICA-TAG objects and sets attributes for this object from data in the intermediate database 304 and creates an ICA-SCOPE container object. An Insert Tags in Scope operation inserts all of the ICA-TAG objects into the ICA-SCOPE container object. Finally, a single rule is applied to establish a relationship between the ICA-SCOPE container and each of the newly created ICA-TAG objects.

(2) Loop and Compound Creation (Step 702)

The task for loop and compound creation together with the two non-managed rule sets associated with this workflow includes a State Info operation used to relay progress information to the user interface. A Get Tags operation unpacks ICA-TAG objects from the ICA-SCOPE object and routes the tag objects to a task for assigning tags to loops.

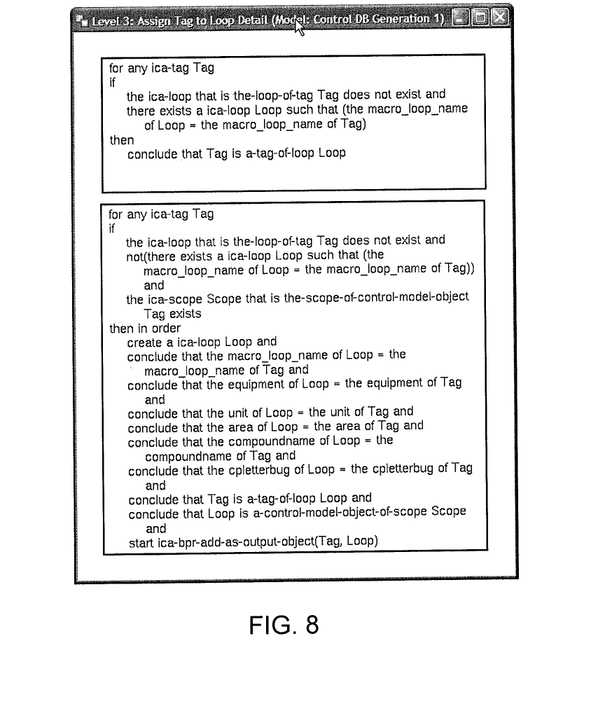

An Assign Tag to Loop operation invokes rules (see, FIG. 8) for assigning tags to a loop. For each ICA-TAG that does not have an associated ICA-LOOP (no loop exists with the same macro loop name as the tag), these non-managed rules create an ICA-LOOP object, conclude several attributes for that loop and then associate the newly-created loop with the tag. Both tags and loops are outputs of the Assign Tag to Loop operation. Tags are added back into the ICA-SCOPE object in an Insert Tags in Scope operation and loops are passed onto the “Assign Loop to Compound” task.

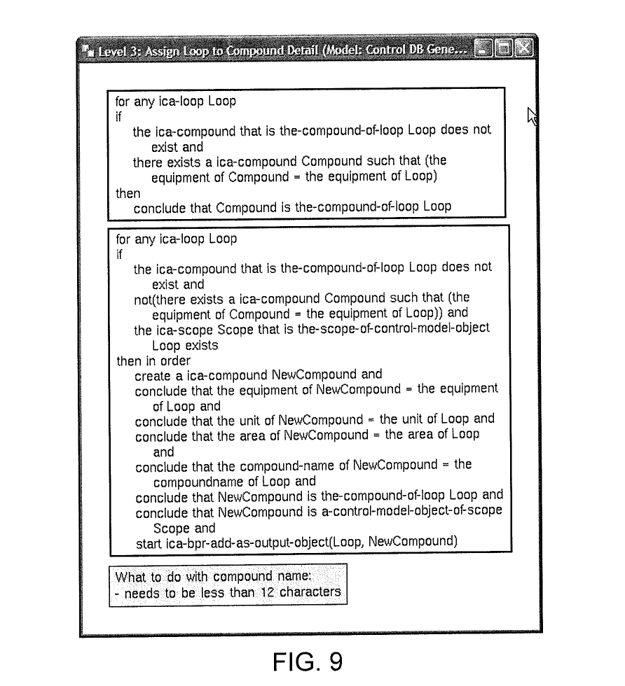

An Assign Loop to Compound operation invokes rules (see, FIG. 9) for assigning Loops to Compounds. For each ICA-LOOP that does not have an associated ICA-COMPOUND (no compound exists with the same “equipment”) these non-managed rules create a new ICA-COMPOUND object, conclude several attributes for the compound and then associate the compound with the loop. Loops and compounds are added back into the ICA-SCOPE object in the tasks labeled “Insert Loops in Scope” and “Insert Compounds in Scope”.

(3) Matching Loops with Templates to Generate Function Blocks (Step 704)

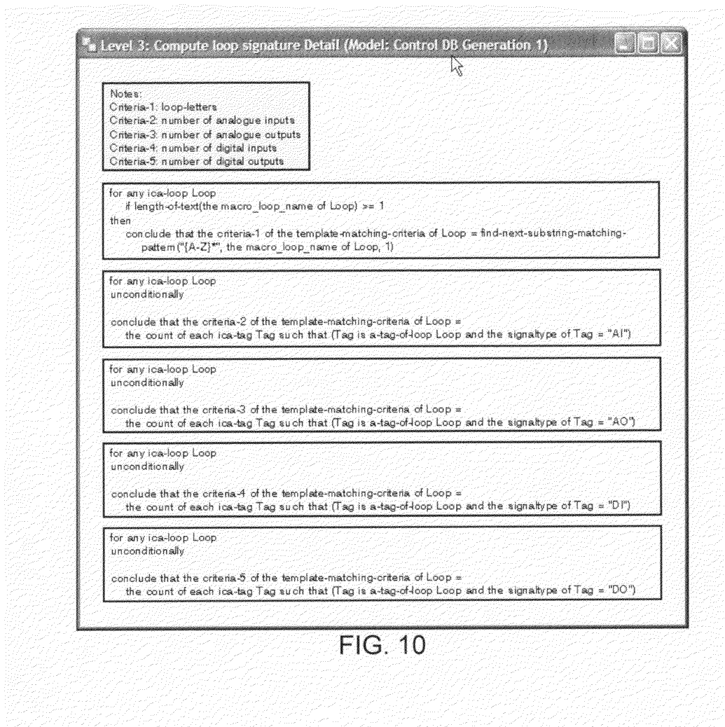

The Match Loops with Templates task (Step 704) contains several operations that result in generation of function blocks. The workflow for the Match Loops with Templates Task 704 task includes a State Info operation to relay progress information to the user interface. A Loop Signature Computation operation sets attributes that uniquely identify loops for the purpose of matching the loop to a specific template. Five managed rules (see, FIG. 10) set a matching criteria based on the macro loop name attribute of a loop, and the signal types (AI, AO, DI, DO) specified for the loop.

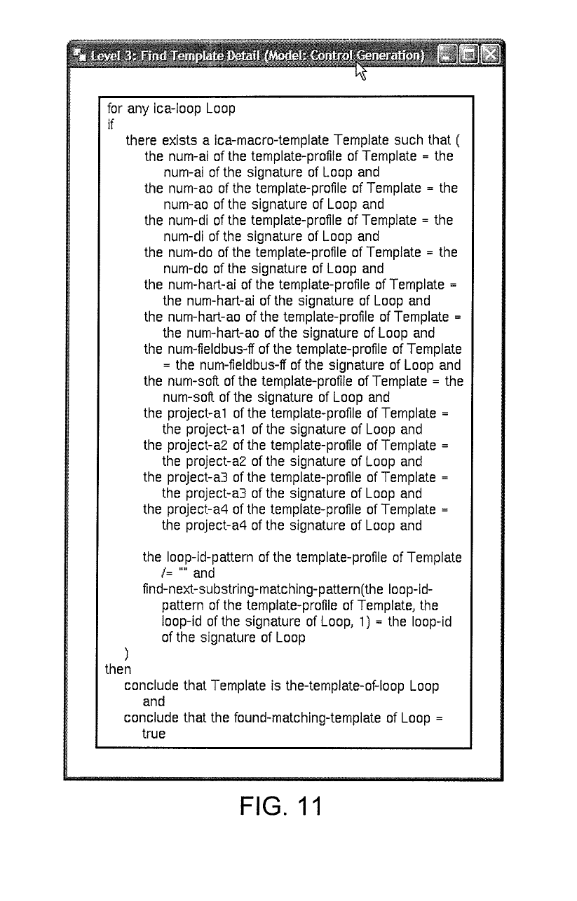

A Find Template operation invokes a single managed rule (see, FIG. 11) that associates a template with a set of pre-existing loop types (ICA-LOOP-TYPE). The template matching criteria set in the Compute Loop Signature operation is matched with the same criteria in a loop type. If an exact match is found, then that loop type is associated with the loop.

A Detect Unmatched Loops operation examines loops to determine if any have not been matched with a Macro Template. All loops that have not been matched are added to a no-matched-templates list, an attribute of the ICA-SCOPE object.

(4) Function Block Generation (Step 706)

The Generate Function Blocks task (Step 706) has four functions:
1. create all function blocks from an identified macro template,
2. allocate the tags in the function blocks that should be inputs or outputs,
3. name the function blocks, and
4. create connections between these blocks, i.e., represent in the CDbG application 500 how function blocks are connected to each other, as specified in the template.

This section of the process control database generation workflow generates the function blocks for each loop from the appropriate macro template that was identified by the signature matching operation described above. The function blocks created from the template are associated with the loop tags where appropriate and named using the rules specified in the user attribute data. The function blocks are associated with each loop before execution of the Function Block Parameter Setting task (step 710) in the workflow.

1. Creating Function Blocks

The function blocks for a loop are generated by cloning the function blocks of the associated macro template. These function blocks do not retain the structure maintained in the template. In other words, sub-templates are not recreated. They are initially updated with a loop name.

2. Tag Association

The loop should already have a set of I/O tags that are associated with the I/O function blocks of the loop. The appropriate tag for each I/O function block is determined by the tag association rule managed rule specified in User Data attributes for the block. The tag association rule typically matches a name of the function block to a tag with a given pattern in its name. Tag association rules use a regular expression stored in the tagname attribute of the User Data attributes of the function block.

3. Block Naming

Block naming is performed by a specific set of managed rules in a similar way to tag association. In this case, the names of the blocks are obtained from the associated tag name or alternatively, the loopname depending whether the block is an I/O block or not.

4. Block Name Validation and Formatting

Block name formatting rules are used to perform tasks such as removing illegal or unnecessary characters from the function block names. If these characters are not removed, it may be impossible to load the loop into the IEE. Block name validation rules perform validation checks on the syntax of the function block names. This would typically be tests such as those to verify that the name that has been generated previously is less than the maximum number of characters allowed.

After setting the function block names, embedded checks (not managed rules) are preformed to verify that all blocks have been assigned names and that all tags of the loop have been assigned to function blocks.

(5) Creating Connections Between Function Blocks (Step 708)

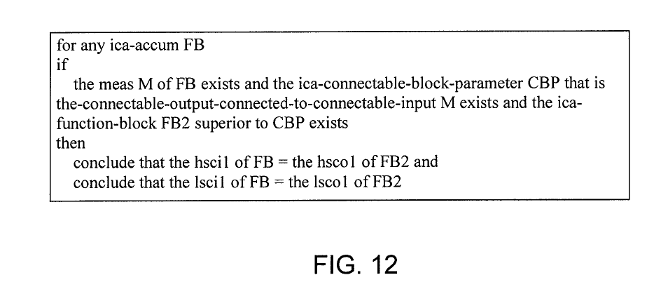

Within templates there can be connections between parameters of function blocks representing a flow of data from an output attribute to an input attribute. A connection is represented by specifying the downstream block and its parameter as the value is in the downstream block parameter. When the template data is loaded from the intermediate database 304, relations are created for connections between function block parameters. The relations are used by the block parameter class-specific managed rules to copy parameters from one block to another. An example of such a rule is provided in FIG. 12. The relation for the-connectable-output-connected-to-connectable-input enables the rule to determine if there is a function block connected at the input of the MEAS parameter of an accum block. If the relation, and thus the connection exists, it copies two attributes from the output block to the input block.

(6) Function Block Parameter Setting (Step 710)

Many of the managed rules applied in the CDbG application 500 are contained in the Set Block Parameters task (Step 710). The operations within the Function Block Parameter Setting task (Step 710) are ordered to first allow setting of default parameters, then perform standard calculations or settings in a batch (or “bulk”) manner, and finally to enable project-specific changes or overrides to any of the default settings or standard calculations. Thus, the operations within the function block parameter setting step 710 are organized into “pre-bulk”, “bulk” and “post-bulk” order.

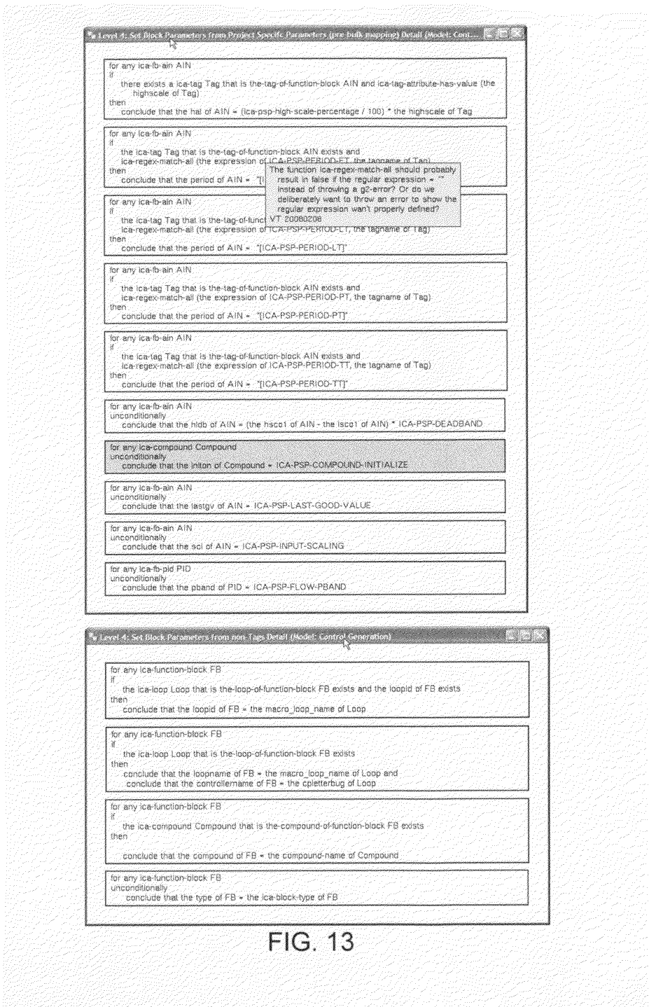

The Pre-Bulk rules (see, FIG. 13), applied during a Pre-bulk mapping operation, set default values for loop ID, loop name, controller name, compound name and type of for each function block. The Pre-Bulk rules also determine a high alarm, period, deadband, last good value, input scaling and flow p-band.

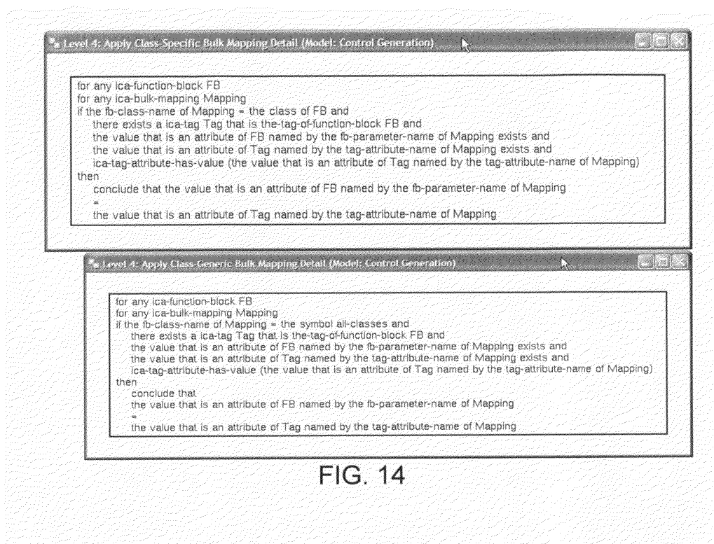

Two Bulk mapping rules shown in FIG. 14, applied during a bulk mapping operation, are defined for function block settings that apply to all function blocks or to specific types of function blocks, respectively. Project engineers, starting from a base set of bulk mapping objects, modify existing or create new bulk mapping objects that will apply desired settings for selected function block parameters.

Finally, a Post-bulk mapping operation of the Set Block Parameters task (Step 710) allows for general and flexible specification of any type of change to function block parameters through the addition of project or customer-specific rules. As with the Bulk Mapping rules, Post-Bulk Mapping is organized into (1) a task for rules that make changes to all function blocks and (2) a task that makes changes specialized to certain types of function blocks. The general form of the rules contained in these tasks must follow this syntax:

for any <sub-class of ica-function-block>

if

<condition>

then

conclude that the <parameter-name> of FB=<some expression>

Ensure that the focal-class of the rule is set to ‘ica-function-block’, or the specific <ica-function-block subclass> to which the rule applies.

### III. Auto-Generation of Process Control Graphics

This portion of the disclosure describes a functional specification for the auto-generation of distributed control system process graphics from an intermediate format. In particular, the generator described herein creates DCS graphics in INVENSYS SYSTEMS, INC. FOXVIEW format from SP P&ID drawing files.

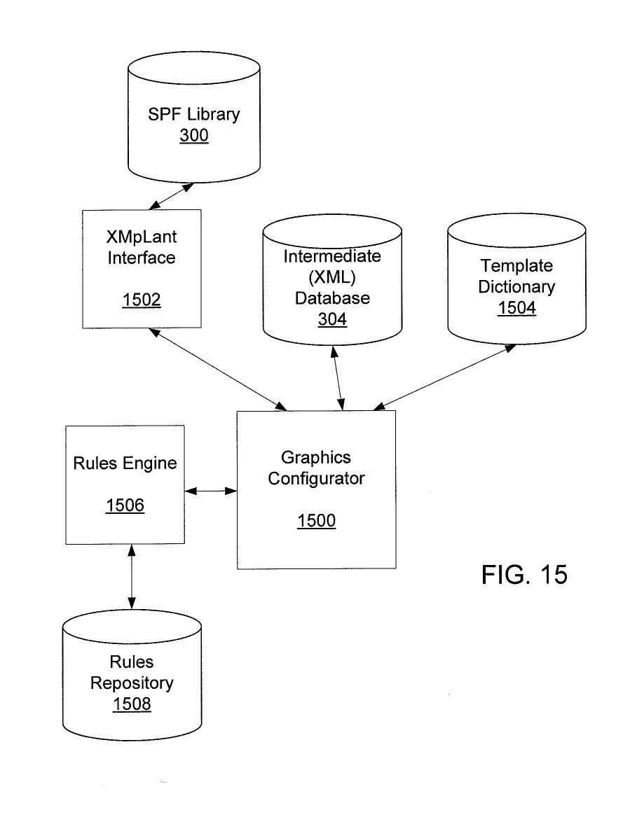

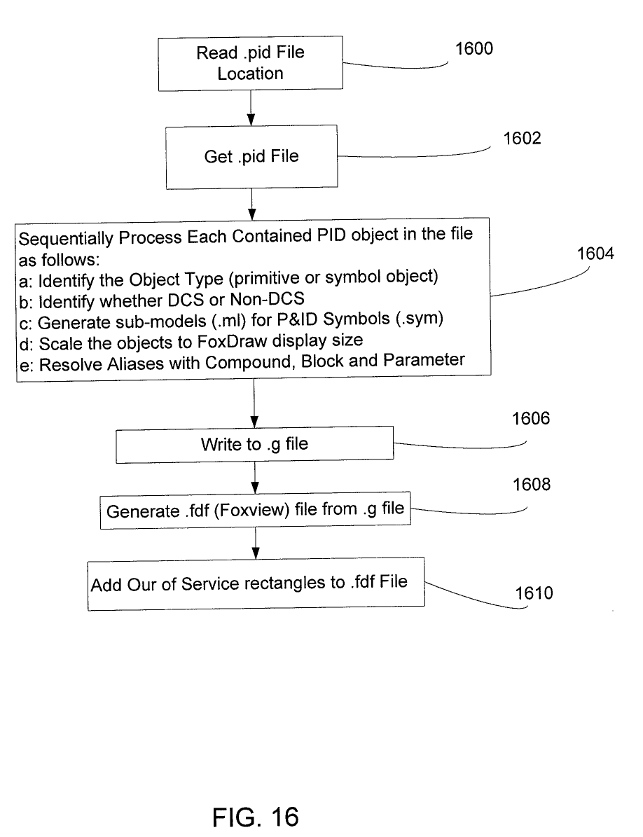

Turning to FIG. 15, the functionality of the automatic process graphics generator is carried out by an arrangement of modules that make up an automatic distributed control system process graphics generator. The specification for such generator is divided into: an auto graphics configurator 1500 for generating process graphics from an intermediate (XML) definition of graphics rendered by an SP P&ID XmPlant interface 1502, and the XMpLant interface 1502 which is an off the shelf product that converts SmartPlant P&ID drawings provided by the SPF library 300 into XML files as per ISO standard 15926.

The auto graphics configurator 1500 converts the SP-P&ID graphics (in XML form) into FOXVIEW process control visualization interface graphics. The auto graphic configurator 1500 is invoked via a process work flow application that is also responsible for invoking the above-described generation of process control databases from XML batch files.

The auto graphics configurator 1500 provides an interface enabling a user to select multiple SP P&ID files and then convert the selected files to FOXVIEW process control graphics (i.e., FoxView .fdf format files). The graphics are initially retrieved from one or more of the following graphics file sources: SP P&ID data from the SPF library 300 via the XMpLant interface 1502, graphics data files from the intermediate database 304, and graphics data from a template dictionary 1504.

In the illustrative example, the auto graphics configurator 1500 provides handshaking signals with a rules management system. Such signals include: start, stop, conversion completed, progress report, and cancel command.

In addition to providing graphics symbols, the auto graphics configurator 1500 resolves aliases associated with generated FoxView graphics. The auto graphics configurator 1500 relies upon a rules engine 1506 having access to a rules repository 1508 to resolve aliases and assign appropriate symbols from matching graphics templates. In operation, the graphics configurator 1500 navigates the set of graphics defined in a source XML graphics file and renders corresponding FOXVIEW graphics.

The template dictionary 1504 enables externalizing graphics templates specified by the project design experts so that the templates can be managed by an administrator. The template dictionary 1504, by way of example, stores the graphics templates in .g (XML) format and .fdf (FoxView) format. The .fdf format can be viewed using the FoxView only. The template dictionary 1504 maintains them in a directory or as a document.

The software architecture of the auto graphics configurator 1500 is similar to the process control database generator described herein above. In particular, the functionality of the auto graphics configurator 1500 is divided into two sub-modules: a graphics adaptor (GA) module and an SP PID (XML) to FoxView (.fdf) graphics generator (xm2g) module. When the auto graphics configurator 1500's graphics generation process is invoked via a user process workflow interface, the GA module takes input graphics data from the intermediate database 304 and invokes the xm2g module to convert a designated SP PID drawing to FoxView display. In response the xm2g module takes the SP PID (XML) files as input and under the guidance of the rules engine 1506 (applying rules similar to those described herein above with reference to the control database generation process) generates the FoxView graphics including resolved aliases (based on specified rules). During the graphics generation process, the GA module periodically polls for the status of xm2g module and updates the same status to a parent workflow process that invoked the GA module. Upon successful completion of bulk generation of the FoxView Graphics, the xm2g module sends a “done” status message to the GA module and waits for a terminate signal from GA module. When the GA module receives the same signal, it sends a terminate command to the xm2g module to initiate the xm2g modules termination.

In accordance with the above, the following logic is carried out by the xm2g module. During step 1600, xm2g module reads the <filename>.pid file and its location from <CLASS-CONFIG>.ini file. Next, during step 1602, the module gets the designated <filename>.pid file from the identified file location and reads the contents of the retrieved file.

Thereafter during step 1604 the xm2g module processes each of the P&ID objects contained in the retrieved file as follows:
a) Identify the object type—primitive or symbol object
b) Identify DCS or non-DCS object
c) Generate sub-models(.m1) for P&ID symbols(.sym)
d) Scales the objects to FoxDraw display size
e) Resolves aliases with Compound, Block, Parameter
   During step 1606 the xm2g module writes the processed information to a <filename>.g file. Thereafter, during step 1608 the xm2g module runs runs g_fdf.exe on the <filename>.g file to generate a FoxView (<filename>.fdf) file. Finally, the xm2g module runs fdf version on the <filename>.fdf file to add oos (out-of-service) rectangles to the display.

In view of the many possible embodiments to which the principles of this invention may be applied, it should be recognized that the embodiments described herein with respect to the drawing figures, as well as the described alternatives, are meant to be illustrative only and should not be taken as limiting the scope of the invention. The functional components disclosed herein can be incorporated into a variety of programmed computer systems as computer-executable instructions stored on computer readable media in the form of software, firmware, and/or hardware. Furthermore, the illustrative steps may be modified, supplemented and/or reordered without deviating from the invention. Therefore, the invention as described herein contemplates all such embodiments as may come within the scope of the following claims and equivalents thereof.

What is claimed is:

1. A method for automatically generating a distributed control system database comprising the steps of:
providing a control system configuration definition in an intermediate schema-based description language;
providing a rules database defining a set of transformations from the intermediate schema-based language to a target control database format; and
applying the set of conversion rules to the control system configuration definition to render a distributed control system database.

2. A system for automatically generating a distributed control system database, the system comprising:
a rules database defining a set of transformations from an intermediate schema-based language to a target control system database format; and
a conversion engine including a set of functions for applying rules from the rules database to a provided control system configuration definition in the intermediate schema-based language to render a distributed control system database.

3. A method for automatically generating distributed control system graphics comprising the steps of:
providing a control system graphics definition in an intermediate schema-based description language;
providing a rules database defining a set of transformations from the intermediate schema-based language to a target graphics format; and
applying transformation rules from the rules database to the control system graphics definition to render distributed control system graphical views.

4. A system for automatically generating distributed control system graphics, the system comprising:
a rules database defining a set of transformations from an intermediate schema-based language to a target control system graphics format; and
a conversion engine including a set of functions for applying rules from the rules database to a provided control system graphics definition in the intermediate schema-based language to render distributed control system graphical views.

5. The system of claim 2 wherein the rules database and conversion engine carry out bulk generation of graphics in FoxView format from SmartPlant P&ID drawings.

6. The system of claim 2 further comprising a rules editor for defining new graphics conversion rules for the rules database.
